(19) United States
(12) Patent Application Publication
(10) Pub. No.: US 2008/0213142 A1
(43) Pub. Date: Sep. 4, 2008

(54) MEMBRANE REACTOR FOR SHIFT REACTION

(75) Inventors: Koichi Katsurayama, Nagoya-City (JP); Koki Hamada, Yokohama-City (JP); Toshiyuki Nakamura, Nagoya-City (JP); Nobuhiko Mori, Nagoya-City (JP); Akira Takahashi, Nagoya-City (JP); Osamu Sakai, Nagoya-City (JP)

Correspondence Address: BURR & BROWN, PO BOX 7068, SYRACUSE, NY, 13261-7068, US

(73) Assignees: NGK Insulators, Ltd., Nagoya-City (JP); IHI Corporation, Koto-Ku (JP)

(21) Appl. No.: 12/042,554

(22) Filed: Mar. 5, 2008

Related U.S. Application Data
(63) Continuation of application No. PCT/JP2006/317762, filed on Sep. 7, 2006.

(30) Foreign Application Priority Data
Sep. 7, 2005 (JP) 2005-259445

(51) Int. Cl. B01J 19/00

(52) U.S. Cl. 422/222; 422/211

(57) ABSTRACT

There is disclosed a membrane reactor 100 for a shift reaction including a selectively permeable membrane 3 having an H₂-selective permeation ability and a catalyst 4 which promotes a chemical reaction, the selectively permeable membrane 3 is a Pd membrane or a Pd alloy membrane, the catalyst 4 is a precious metal catalyst, and the selectively permeable membrane preferably has a thickness of 20 μm or less. The membrane reactor 100 for the shift reaction simultaneously performs inhibition of a methanation reaction and progression of a shift reaction while preventing deterioration of a thinly formed selectively permeable membrane, whereby hydrogen can efficiently be collected.

### TECHNICAL FIELD

The present invention relates to a membrane reactor for a shift reaction. More particularly, it relates to a membrane reactor for a shift reaction which simultaneously performs inhibition of a methanation reaction and progression of the shift reaction while preventing deterioration of a thinly formed selectively permeable membrane, whereby hydrogen can efficiently be collected.

### BACKGROUND ART

A hydrogen gas is used in large quantities as a basic material gas of petrochemistry, and greatly expected as a clean energy source. The hydrogen gas for use in such a purpose is produced from a main raw material gas of hydrocarbon such as methane, butane or kerosene, or oxygen-containing hydrocarbon such as methanol by use of a reforming reaction, a partial oxidizing reaction, a decomposing reaction or the like, and produced by further performing a shift reaction using by-products of carbon monoxide and water as materials. Hydrogen produced in this manner can be separated and taken using a selectively permeable membrane or the like capable of selectively passing hydrogen, for example, a palladium alloy membrane.

As described above, the shift reaction is a reaction positioned at a subsequent stage of the reforming reaction or the like in a hydrogen manufacturing process. From viewpoints of a thermodynamic restriction and speed, the shift reaction is usually constituted of two-stage processes of a high temperature shift reaction and a low temperature shift reaction. Industrially, an iron chromic catalyst is usually used in the high temperature shift reaction of 300 to 500° C. A shift reaction using a precious metal catalyst is also investigated (e.g., see Patent Document 1).

The shift reaction is a reaction expressed in the next (a):

CO+H₂O=CO₂+H₂ (a).

In the shift reaction in which a reforming gas is used as a raw material gas, the following methanation reaction could occur as a side reaction, but when the above iron chromic catalyst is used, the only shift reaction selectively progresses.

The methanation reaction is a reaction expressed in the next (b):

CO+3H₂=CH₄+H₂O (b).

Moreover, a membrane reactor (a membrane reactor for a shift reaction) is also known which simultaneously performs the above shift reaction and separation of hydrogen. As an example of the membrane reactor for use, the membrane reactor is prepared using, for example, a Pd membrane having a thickness of 20 μm and an iron chromium catalyst, and a principle of an effect on the shift reaction is demonstrated (e.g., see Non-Patent Document 1).

In such a conventional membrane reactor for the shift reaction, since the Pd membrane is thick, a permeation performance of the Pd membrane is not sufficient, and it is difficult to efficiently collect hydrogen.

Patent Document 1: Japanese Patent Application Laid-Open No. 2004-284912; and

Non-Patent Document 1: Eiichi Kikuchi et al., Chemistry Letters (1989) pp. 489 to 492.

### DISCLOSURE OF THE INVENTION

To improve a permeation performance of a Pd membrane, it is preferable to form the Pd membrane to be thin. However, in a membrane reactor for a shift reaction using the thin Pd membrane and an iron chromic catalyst which is a conventional catalyst, in a case where the Pd membrane comes in contact with iron as a catalyst component at a high temperature, there has been a problem that a selectively permeable membrane deteriorates in a remarkably short time owing to the reaction. A deterioration rate of the selectively permeable membrane becomes remarkable, as the thickness of the Pd membrane decreases. Furthermore, as a reaction temperature rises, the rate remarkably increases.

As a performance required for the high temperature shift reaction catalyst, it is demanded that the catalyst should have activity to the shift reaction and that a methanation reaction as a side reaction should not occur. It is known that the methanation reaction does not progress at a temperature of 500° C. or less in an iron chromium catalyst which is usually used at present. On the other hand, the methanation reaction progresses in a precious metallic shift catalyst. Furthermore, as the reaction temperature rises, a degree of progression of the methanation reaction increases.

The present invention has been developed in view of the above-mentioned problem, and is characterized by providing a membrane reactor for a shift reaction which simultaneously performs inhibition of a methanation reaction and progression of the shift reaction while preventing deterioration of a thinly formed selectively permeable membrane, whereby hydrogen can efficiently be collected.

To achieve the above object, according to the present invention, there is provided the following membrane reactor for the shift reaction.

[1] A membrane reactor for a shift reaction which comprises a selectively permeable membrane having an H₂-selective permeation ability and a catalyst configured to promote a chemical reaction, the selectively permeable membrane being a Pd membrane or a Pd alloy membrane, the catalyst being a precious metal catalyst.

[2] The membrane reactor for the shift reaction according to [1], wherein the selectively permeable membrane has a thickness of 20 μm or less.

[3] The membrane reactor for the shift reaction according to [1] or [2], wherein a Pd alloy forming the selectively permeable membrane is a Pd—Ag alloy or a Pd—Cu alloy.

[4] The membrane reactor for the shift reaction according to any one of [1] to [3], wherein the precious metal catalyst is constituted of a precious metal carried on a carrier made of a porous inorganic oxide including at least one selected from the group consisting of Ti, Al, Zr, Ce, Si and Mg.

[5] The membrane reactor for the shift reaction according to [4], wherein the precious metal carried on the precious metal catalyst includes at least one selected from the group consisting of Ru, Rh, Pd, Ag, Ir, Pt and Au.

[6] The membrane reactor for the shift reaction according to any one of [1] to [5], wherein the precious metal catalyst is carried on a pellet-like, foam-like or honeycomb-like base material, or the precious metal catalyst itself is formed into a pellet-like, foam-like or honeycomb-like state.

[7] The membrane reactor for the shift reaction according to any one of [1] to [6], wherein a hydrogen collection ratio defined by the following equation (1) is in a range of 20 to 99.9 vol %:

[hydrogen collection ratio]=100×{[permeation-side hydrogen flow rate]/([non-permeation-side hydrogen flow rate]+[permeation-side hydrogen flow rate])} (1),

in which the permeation-side hydrogen flow rate is a flow rate (m³/hr) of hydrogen that has permeated the selectively permeable membrane, and the non-permeation-side hydrogen flow rate is a flow rate (m³/hr) of hydrogen to be passed through the reactor and discharged from the reactor without permeating the selectively permeable membrane.

In the membrane reactor for the shift reaction in which the Pd membrane or the Pd alloy membrane is embedded as the selectively permeable membrane, the precious metal catalyst which does not easily react with the membrane is used as the catalyst, so that a reaction between the membrane and the catalyst which raises a problem in a case where an iron chromium catalyst is used is inhibited. Therefore, rapid deterioration of the membrane is prevented. Furthermore, hydrogen permeates the Pd membrane or the Pd alloy membrane and is discharged from a reaction system, so that the inhibition of the methanation reaction and the progression of the shift reaction can simultaneously be performed, and hydrogen can efficiently be collected.

### BRIEF DESCRIPTION OF THE DRAWINGS

FIG. 1 schematically shows a membrane reactor for a shift reaction according to the present invention, FIG. 1(a) is a plan view, and FIG. 1(b) is a sectional view cut along a plane including a central axis;

FIG. 2 is a schematic diagram showing a constitution of a test device used in examples;

FIG. 3 is a graph showing test results concerning reactions in the examples; and

FIG. 4 is a graph showing test results concerning the reactions in the examples.

### DESCRIPTION OF REFERENCE NUMERALS

1: a reactor, 2: a separation tube, 3: a selectively permeable membrane, 4: a catalyst, 11: an inlet, 12: an outlet, and 100: a membrane reactor for a shift reaction.

### BEST MODE FOR CARRYING OUT THE INVENTION

The best mode (hereinafter referred to as the “embodiment”) for carrying out the present invention will hereinafter specifically be described, but it should be understood that the present invention is not limited to the following embodiment and that design is appropriately altered or modified based on ordinary knowledge of any person skilled in the art without departing from the scope of the present invention.

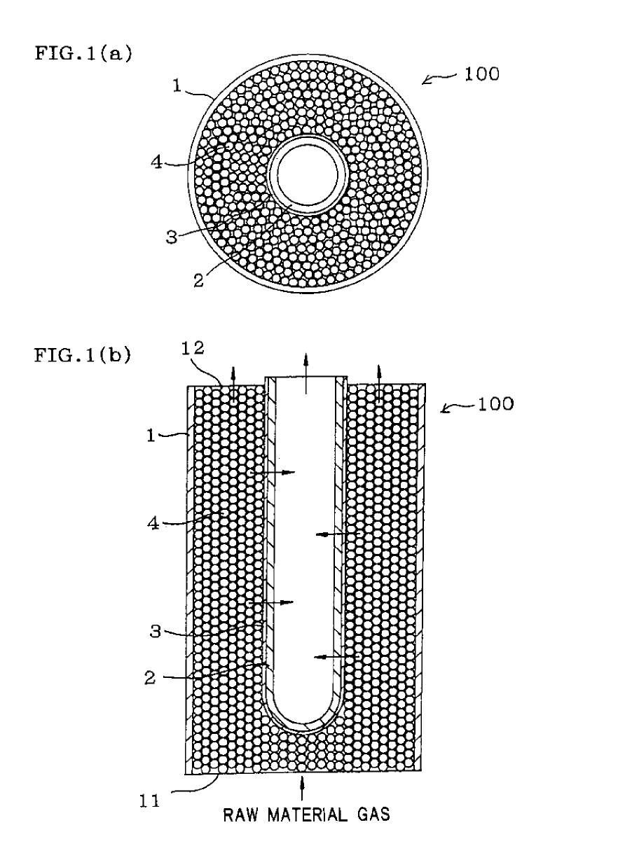

FIGS. 1(a) and 1(b) are diagrams schematically showing one embodiment of a membrane reactor for a shift reaction according to the present invention, FIG. 1(a) is a plan view, and FIG. 1(b) is a sectional view cut along a plane including a central axis. As shown in FIGS. 1(a) and 1(b), a membrane reactor 100 for the shift reaction of the present embodiment has a cylindrical reactor 1 including one end which is an inlet 11 of a gas and the other end which is an outlet 12 of the gas, a bottomed cylindrical separation tube 2 inserted in the reactor 1, having a selectively permeable membrane 3 on the surface thereof and including a porous base portion, and a catalyst 4 arranged between the reactor 1 and the separation tube 2.

The catalyst 4 has a pellet shape, a void between the reactor 1 and the separation tube 2 is filled with the catalyst in the form of a packed bed, and a reforming gas supplied from the inlet 11 comes in contact with this catalyst 4 to react carbon monoxide with water in the reforming gas, thereby producing hydrogen and carbon dioxide.

In the membrane reactor 100 for the shift reaction of the present embodiment, the selectively permeable membrane 3 is a Pd membrane or a Pd alloy membrane, and the catalyst 4 is a precious metal catalyst.

A precious metal has reactivity with palladium (Pd) or a Pd alloy which is lower than that of an iron chromium catalyst, so that deterioration of the Pd membrane or the Pd alloy membrane can be prevented, and the shift reaction can be continued for a long time. Moreover, hydrogen produced by the shift reaction and hydrogen contained in the reforming gas as a raw material gas permeate the Pd membrane or the Pd alloy membrane, and flow into a permeation side (the inside of the separation tube 2 in FIG. 1(b)), so that a hydrogen partial pressure of a space (a non permeation side) filled with the catalyst lowers. Therefore, in the shift reaction represented by the above equation (a), hydrogen as a product is extracted, and hence the reaction is promoted. On the other hand, in the methanation reaction represented by the above equation (b) hydrogen as the product is extracted, and hence the reaction is inhibited. Then, such a membrane reactor for the shift reaction according to the present embodiment can efficiently collect hydrogen.

In the membrane reactor 100 for the shift reaction of the present embodiment shown in FIGS. 1(a), 1(b), it is preferable that the selectively permeable membrane 3 has a thickness of preferably 20 μm or less, further preferably 0.005 to 10 μm, especially preferably 0.01 to 5 μm, most preferably 0.05 to 3.0 μm. When the thickness exceeds 20 μm, a permeation rate of hydrogen lowers. Moreover, as the thickness of the selectively permeable membrane 3 decreases, hydrogen easily permeates the membrane, and hydrogen can efficiently be collected. However, if the membrane is excessively thin, durability and hydrogen selectivity of the membrane sometimes deteriorate.

As the Pd alloy forming the selectively permeable membrane 3, a Pd—Ag alloy or a Pd—Cu alloy is preferable from the viewpoints of durability and hydrogen permeation performance. Hydrogen can efficiently and selectively permeate the membrane made of this alloy.

As the porous separation tube 2 having the selectively permeable membrane 3 formed on the surface thereof, a ceramic porous member constituted of a material such as alumina (Al₂O₃) or titania (TiO₂) or a metallic porous member of a stainless steel or the like may be used. If necessary, the selectively permeable membrane 3 may be disposed on the permeation side of the separation tube 2, not on the non-permeation side of the separation tube 2, and both sides of the separation tube 2 may be coated with selectively permeable membranes. It is to be noted that a shape of the separation tube is not limited to a tubular shape, and a flat plate-like shape may be used as long as the gas as a separation target is separated into the non-permeation side and the permeation side.

In the membrane reactor 100 for the shift reaction of the present embodiment shown in FIGS. 1(a) and 1(b), it is preferable that the precious metal contained in the catalyst (the precious metal catalyst) 4 is at least one selected from the group consisting of Ru, Rh, Pd, Ag, Ir, Pt and Au. Among them, Pt, Au are especially preferable. These precious metals are used, whereby the shift reaction represented by the above equation (a) efficiently progresses, and hydrogen can be obtained.

It is preferable that the catalyst 4 is constituted of the precious metal carried on a carrier made of a porous inorganic oxide. Examples of the porous inorganic oxide include an oxide of at least one member selected from the group consisting of Ti, Al, Zr, Ce, Si and Mg. Among them, Ti, Zr are especially preferable. Moreover, a content ratio of the whole substance of Ti or the like with respect to the whole porous inorganic oxide is preferably 30 mass % or more, further preferably 50 mass % or more. As a catalyst shape, such a shape that a surface area of the catalyst enlarges is preferable, and a pellet-like, foam-like or honeycomb-like catalyst may be used.

The membrane reactor for the shift reaction of the present embodiment allows the shift reaction to progress while inhibiting the methanation reaction, whereby hydrogen can efficiently be collected, but it is preferable that a hydrogen collection ratio defined by the following equation (1) is in a range of preferably 20 to 99.9 vol %, further preferably 40 to 99.5 vol %, especially preferably 60 to 99.0 vol %, most preferably 80 to 99.0 vol %. As the hydrogen collection ratio increases, a hydrogen partial pressure in a reaction field decreases, so that the resultant effect of the inhibition of the methanation reaction and the promotion of the shift reaction enhances. On the other hand, for improvement of the hydrogen collection ratio, in addition to improvement of a membrane performance, a flow rate of the raw material gas needs to be reduced, and it is difficult to obtain a hydrogen collection ratio of 100%.

[hydrogen collection ratio]=100×{[permeation-side hydrogen flow rate]/([non-permeation-side hydrogen flow rate]+[permeation-side hydrogen flow rate])} (1),

in which the permeation-side hydrogen flow rate is a flow rate (m³/hr) of hydrogen that has permeated the selectively permeable membrane, and the non-permeation-side hydrogen flow rate is a flow rate (m³/hr) of hydrogen to be passed through the reactor and discharged from the reactor without permeating the selectively permeable membrane.

To raise the hydrogen collection ratio, it is preferable to enlarge a hydrogen partial pressure difference between the non-permeation side and the permeation side. Specifically, a preferable method is a method for passing a sweep gas such as a steam through the separation tube (a permeation outlet side), lowering a permeation-side pressure with a vacuum pump, or raising a pressure on a reaction side (the non-permeation side). These methods may be performed alone, but the methods may simultaneously be performed to obtain a higher effect.

When the shift reaction is performed using the membrane reactor 100 for the shift reaction according to the present embodiment shown in FIGS. 1(a), 1(b), first the reforming gas obtained by reacting methane with the steam and containing carbon monoxide, carbon dioxide, water, hydrogen, unreacted methane or the like is allowed to flow into the reactor 1 from the inlet 11. Then, the shift reaction between carbon monoxide and water in the reforming gas is performed via the catalyst 4 to obtain hydrogen and carbon dioxide. Hydrogen obtained by a reforming reaction and hydrogen obtained by the shift reaction selectively permeate the selectively permeable membrane 3 to flow into the permeation side, and are discharged (collected) from the reactor. Furthermore, hydrogen which has not flowed into the separation tube 2 and other components are discharged from the outlet 12 of the reactor 1.

A reaction temperature at a time when the shift reaction is performed is in a range of preferably 150 to 600° C., further preferably 175 to 575° C., especially preferably 200 to 550° C. When the temperature is lower than 150° C., there is a fear of deterioration of the membrane and insufficiency of catalyst activity due to embrittlement of hydrogen. On the other hand, when the temperature is higher than 600° C., in addition to the deterioration of the membrane, there is a fear of increase of the methanation reaction due to low selectivity of the catalyst. In a case where the membrane reactor for the shift reaction according to the present embodiment is used, a hydrogen refinement process which has heretofore been constituted of multiple stages can be replaced with a process of one stage, so that the process is advantageous in respect of energy efficiency and compactness of a device as compared with a conventional process.

As the flow rate of the raw material gas at a time when the shift reaction is performed, an optimum flow rate can appropriately be selected in accordance with sizes of the reactor and the separation tube, a thickness and an area of the selectively permeable membrane and the like.

### EXAMPLES

The present invention will hereinafter be described further specifically in accordance with examples, but the present invention is not limited to these examples.

(Preparation of Reactor)

### Example 1

A separation tube was constituted of a bottomed cylindrical alumina porous member (an outer diameter of 10 mm, a length of 75 mm) having one closed end, and a 75% Pd-25% Ag alloy membrane selectively permeated by hydrogen was formed as a selectively permeable membrane into a thickness of 20 μm on the surface of the separation tube by plating. This separation tube was inserted into a cylindrical reaction tube made of stainless steel (SUS) (an inner diameter of 250 mm, a length of 350 mm). A catalyst was prepared by carrying Pt on outer surfaces of 3 mmΦ titania pellets by a dip process. A void between the reaction tube and the separation tube was filled with the catalyst in the form of a packed bed as shown in FIG. 1.

### Example 2

A reactor was prepared in the same manner as in Example 1 except that a thickness of a selectively permeable membrane (a 75% Pd-25% Ag alloy membrane) was set to 3 μm.

### Example 3

A reactor was prepared in the same manner as in Example 1 except that a thickness of a selectively permeable membrane (a 75% Pd-25% Ag alloy membrane) was set to 1 μm.

### Example 4

A reactor was prepared in the same manner as in Example 1 except that a thickness of a selectively permeable membrane (a 75% Pd-25% Ag alloy membrane) was set to 0.5 μm.

### Example 5

A reactor was prepared in the same manner as in Example 1 except that a thickness of a selectively permeable membrane (a 75% Pd-25% Ag alloy membrane) was set to 0.05 μm.

### Example 6

A reactor was prepared in the same manner as in Example 1 except that a thickness of a selectively permeable membrane (a 75% Pd-25% Ag alloy membrane) was set to 30 μm.

### Example 7

A reactor was prepared in the same manner as in Example 1 except that a thickness of a selectively permeable membrane (a 75% Pd-25% Ag alloy membrane) was set to 0.005 μm.

### Example 8

A separation tube was constituted of a bottomed cylindrical alumina porous member (an outer diameter of 10 mm, a length of 75 mm) having one closed end, and a 75% Pd-25% Ag alloy membrane selectively permeated by hydrogen was formed as a selectively permeable membrane into a thickness of 2.5 μm on the surface of the separation tube by plating. This separation tube was inserted into a cylindrical reaction tube made of SUS (an inner diameter of 250 mm, a length of 350 mm). A catalyst was prepared by carrying Pt on outer surfaces of 3 mmΦ alumina pellets by a dip process. A void between the reaction tube and the separation tube was filled with this catalyst in the form of a packed bed as shown in FIG. 1.

### Example 9

A separation tube was constituted of a bottomed cylindrical alumina porous member (an outer diameter of 10 mm, a length of 75 mm) having one closed end, and a 75% Pd-25% Ag alloy membrane selectively permeated by hydrogen was formed as a selectively permeable membrane into a thickness of 2.5 μm on the surface of the separation tube by plating. This separation tube was inserted into a cylindrical reaction tube made of SUS (an inner diameter of 250 mm, a length of 350 mm). A catalyst was prepared by carrying Pt on outer surfaces of 3 mmΦ titania pellets by a dip process. A void between the reaction tube and the separation tube was filled with this catalyst in the form of a packed bed as shown in FIG. 1.

### Comparative Example 1

A catalyst was prepared by carrying Pt on outer surfaces of 3 mmΦ titania pellets by a dip process. A cylindrical reaction tube made of SUS (an inner diameter of 250 mm, a length of 350 mm) was filled with this catalyst in the form of a packed bed.

### Comparative Example 2

As a catalyst, an iron-chromic catalyst (a size of about 3 mm) was used in the form of pellets, and a cylindrical reaction tube made of SUS (an inner diameter of 250 mm, a length of 350 mm) was filled with this catalyst in the form of a packed bed.

### Comparative Example 3

A separation tube was constituted of a bottomed cylindrical alumina porous member (an outer diameter of 10 mm, a length of 75 mm) having one closed end, and a 75% Pd-25% Ag alloy membrane selectively permeated by hydrogen was formed as a selectively permeable membrane into a thickness of 30 μm on the surface of the separation tube by plating. This separation tube was inserted into a cylindrical reaction tube made of SUS (an inner diameter of 250 mm, a length of 350 mm). As a catalyst, an iron-chromic catalyst (a size of about 3 mm) was used in the form of pellets. A void between the reaction tube and the separation tube was filled with this catalyst in the form of a packed bed as shown in FIG. 1.

### Comparative Examples 4 to 9

Reactors were prepared in the same manner as in Comparative Example 3 except that thicknesses of selectively permeable membranes (75% Pd-25% Ag alloy membranes) were set to 20 μm (Comparative Example 4), 3 μm (Comparative Example 5), 1 μm (Comparative Example 6), 0.5 μm (Comparative Example 7), 0.05 μm (Comparative Example 8) and 0.005 μm (Comparative Example 9), respectively.

### Comparative Example 10

A catalyst was prepared by carrying Pt on outer surfaces of 3 mmΦ alumina pellets by a dip process. A cylindrical reaction tube made of SUS (an inner diameter of 250 mm, a length of 350 mm) was filled with this catalyst in the form of a packed bed.

(Durability Test and Test on Reaction)

(Device)

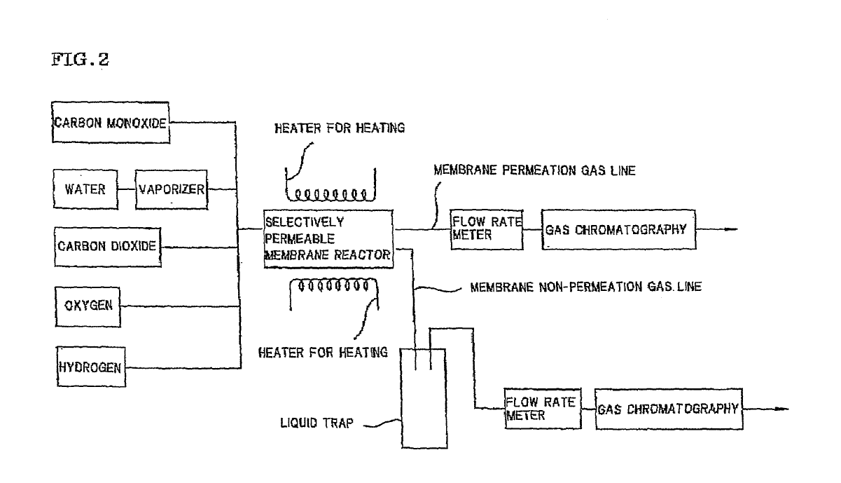

A device shown in FIG. 2 was used, and the selectively permeable membrane reactors of Examples 1 to 9 and Comparative Examples 3 to 9 and the non-membrane reactors of Comparative Examples 1, 2 and 10 were evaluated. A linearly connected device was provided so as to use carbon monoxide, carbon dioxide, hydrogen and water as a raw material gas source, and if necessary, they can be selected, mixed and supplied to the selectively permeable membrane reactor. Water is vaporized with a vaporizer and supplied. Downstream sides of a membrane permeation side gas line and a membrane non-permeation side gas line are connected to a membrane permeation side (an inner part of a separation tube) and a membrane non-permeation side (an outlet of a reaction tube) of the selectively permeable membrane reactor, respectively. A downstream side of the membrane permeation side gas line is connected to a flow rate meter for measuring a gas amount and a gas chromatography for determining gas components. A downstream side of the membrane non-permeation gas line is similarly connected to a flow rate meter and a gas chromatography. Furthermore, a trap set to about 5° C. to trap a liquid component such as water is provided on an upstream side of the flow rate meter. Moreover, heaters for heating are installed around the selectively permeable membrane reactor so that an outer part of the reactor can be heated. When the non-membrane reactors of Comparative Examples 1, 2 and 10 were evaluated, the non-membrane reactors of Comparative Examples 1, 2 and 10 were installed in a position of the selectively permeable membrane reactor shown in FIG. 2, and a gas discharged from the non-membrane reactors of Comparative Examples 1, 2 and 10 was discharged on the membrane non-permeation gas line side.

(Reaction)

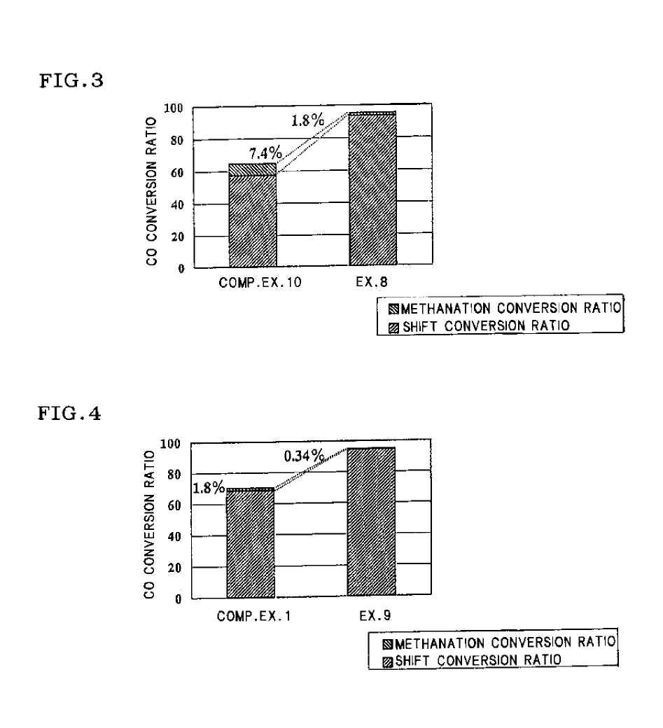

As a raw material gas, a simulated reforming gas (H₂:CO:CO₂:H₂O=56:11:6:27 in terms of a molar fraction) was supplied. A shift reaction as a reaction between carbon monoxide and water was performed, and hydrogen was selectively separated from a reaction product. A reaction temperature was adjusted into 400° C., a reaction-side pressure was set to 3 atm, and a permeation-side pressure was set to 0.1 atm. A gas flow rate and a gas composition on a membrane permeation side and a membrane non-permeation side were checked, whereby a hydrogen purity, a CO conversion ratio, a shift conversion ratio and a methanation conversion ratio were calculated. Table 1 shows “test results concerning durability” of the reactors of Examples 1 to 7 and Comparative Examples 1 to 9, and FIGS. 3, 4 show “test results concerning the reaction” in the reactors of Examples 8, 9 and Comparative Examples 1, 10. Here, the shift conversion ratio and the methanation conversion ratio are defined as follows. The shift conversion ratio is a ratio of carbon monoxide consumed in the shift reaction, and the methanation conversion ratio is a ratio of carbon monoxide consumed in a methanation reaction. A value obtained by adding up the shift conversion ratio and the methanation conversion ratio is a CO conversion ratio. The conversion ratio [%] is a [mol %].

Shift conversion ratio [%]=100×(inlet CO flow rate-outlet CO flow rate-outlet CH₄ flow rate)/inlet CO flow rate

Methanation conversion ratio [%]=100×outlet CH₄ flow rat/inlet CO flow rate

CO conversion ratio [%]=shift conversion ratio+methanation conversion ratio

TABLE 1

| | | Membrane | Hydrogen purity [%] | | CO conversion ratio [%] | |
|---|---|---|---|---|---|---|
| | | thickness | 30 min after | 1000 hr after | 30 min after | 1000 hr after |
| | Catalyst | [μm] | start of reaction | start of reaction | start of reaction | start of reaction |
| Comparative | Pt/TiO₂ | No membrane | | | 69 | 69 |
| Example 1 | | | | | | |
| Example 6 | Pt/TiO₂ | 30 | 99.99 | 99.99 | 75 | 75 |
| Example 1 | Pt/TiO₂ | 20 | 99.91 | 99.91 | 86 | 86 |
| Example 2 | Pt/TiO₂ | 3 | 99.86 | 99.84 | 93 | 93 |
| Example 3 | Pt/TiO₂ | 1 | 99.78 | 99.77 | 96 | 95 |
| Example 4 | Pt/TiO₂ | 0.5 | 99.77 | 99.75 | 97 | 97 |
| Example 5 | Pt/TiO₂ | 0.05 | 99.65 | 99.61 | 99 | 99 |
| Example 7 | Pt/TiO₂ | 0.005 | 97.1 | 95.2 | 98 | 96 |
| Comparative | Iron/chromium | No membrane | | | 69 | 69 |
| Example 2 | | | | | | |
| Comparative | Iron/chromium | 30 | 99.99 | 95.81 | 76 | 73 |
| Example 3 | | | | | | |
| Comparative | Iron/chromium | 20 | 99.89 | 85.12 | 86 | 72 |
| Example 4 | | | | | | |
| Comparative | Iron/chromium | 3 | 99.82 | 77.73 (breakage) | 93 | 70 |
| Example 5 | | | | | | |
| Comparative | Iron/chromium | 1 | 99.81 | 76.33 (breakage) | 96 | 70 |
| Example 6 | | | | | | |
| Comparative | Iron/chromium | 0.5 | 99.74 | 76.45 (breakage) | 98 | 69 |
| Example 7 | | | | | | |
| Comparative | Iron/chromium | 0.05 | 99.53 | 76.23 (breakage) | 99 | 69 |
| Example 8 | | | | | | |
| Comparative | Iron/chromium | 0.005 | 99.03 | 76.74 (breakage) | 97 | 69 |
| Example 9 | | | | | | |

(Test Result concerning Durability)

In Example 6 and Comparative Example 3 in which a membrane thickness was large, a hydrogen permeation rate was low, and hence a degree of improvement of the CO conversion ratio was slightly small as compared with a case where any membrane was not used, but in Example 6, a Pt/TiO₂ catalyst was used, so that a Pd membrane deteriorated little, and a hydrogen purity in 1000 hours after start of a reaction did not lower at all, and maintained in a remarkably high state. In a case where an iron chromium catalyst was used, in Comparative Examples 4 to 8 in which the membrane thickness was large, remarkable deterioration of the membrane was confirmed. A change of a micro structure of the surface of the Pd membrane which was supposed to be caused by a reaction between Pd and iron was confirmed with an SEM. With the deterioration of the membrane, an effect of extraction of hydrogen was reduced, and hence the CO conversion ratio lowered. In Comparative Examples 5 to 9 in which the membrane was broken after elapse of 1000 hours, the CO conversion ratio was equal to that of Comparative Example 2 in which any membrane was not used. In a case where the Pt/TiO₂ catalyst was used, the deterioration of the membrane caused by contact between the membrane and the catalyst was prevented. When the surface of the Pd membrane was observed with the SEM, any change of the micro structure of the Pd surface was not confirmed before and after the reaction. Moreover, in Example 7 in which the membrane thickness was remarkably small, initial air-tightness was slightly unsatisfactory, but the Pd membrane had a high permeation performance, and hence the CO conversion ratio indicated a high value. Therefore, conditions of Examples 1 to 7 are preferable, but from a viewpoint of the resultant hydrogen purity and CO conversion ratio, conditions of Examples 1 to 5 are most preferable.

(Test Result concerning Reaction)

Results obtained from catalysts only in Comparative Examples 1, 10 (non-membrane reactors) were compared with those obtained from membrane reactors. The results of Example 8 and Comparative Example 10 in which a Pt/Al₂O₃ catalyst was used are shown in FIG. 3, and the results of Example 9 and Comparative Example 1 in which a Pt/TiO₂ catalyst was used are shown in FIG. 4, respectively. When a precious metal catalyst is used, a methanation reaction slightly progresses as a side reaction. However, it has been seen that in the membrane reactor combined with the membrane, as heretofore found, a higher shift conversion ratio is obtained, and additionally an inhibition effect of the methanation reaction can be obtained. Hydrogen collection ratios of Examples 8 and 9 defined by the above equation (1) were 91.6 vol % and 92.4 vol %, respectively.

### INDUSTRIAL APPLICABILITY

The present invention can be installed in a subsequent stage of a reforming reaction or the like in a hydrogen manufacturing process, and can be used in efficiently collecting hydrogen.

1-7. (canceled)

8. A membrane reactor for a shift reaction which comprises a selectively permeable membrane having an H₂-selective permeation ability and a catalyst configured to promote a chemical reaction,
the selectively permeable membrane being a Pd membrane or a Pd alloy membrane, the catalyst being a precious metal catalyst.

9. The membrane reactor for the shift reaction according to claim 8, wherein the selectively permeable membrane has a thickness of 20 μm or less.

10. The membrane reactor for the shift reaction according to claim 8, wherein a Pd alloy forming the selectively permeable membrane is a Pd—Ag alloy or a Pd—Cu alloy.

11. The membrane reactor for the shift reaction according to claim 9, wherein a Pd alloy forming the selectively permeable membrane is a Pd—Ag alloy or a Pd—Cu alloy.

12. The membrane reactor for the shift reaction according to claim 8, wherein the precious metal catalyst is constituted of a precious metal carried on a carrier made of a porous inorganic oxide including at least one selected from the group consisting of Ti, Al, Zr, Ce, Si and Mg.

13. The membrane reactor for the shift reaction according to claim 12, wherein the precious metal carried on the precious metal catalyst includes at least one selected from the group consisting of Ru, Rh, Pd, Ag, Ir, Pt and Au.

14. The membrane reactor for the shift reaction according to claim 8, wherein the precious metal catalyst is carried on a pellet-like, foam-like or honeycomb-like base material, or the precious metal catalyst itself is formed into a pellet-like, foam-like or honeycomb-like state.

15. The membrane reactor for the shift reaction according to claim 12, wherein the precious metal catalyst is carried on a pellet-like, foam-like or honeycomb-like base material, or the precious metal catalyst itself is formed into a pellet-like, foam-like or honeycomb-like state.

16. The membrane reactor for the shift reaction according to claim 13, wherein the precious metal catalyst is carried on a pellet-like, foam-like or honeycomb-like base material, or the precious metal catalyst itself is formed into a pellet-like, foam-like or honeycomb-like state.

17. The membrane reactor for the shift reaction according to claim 8, wherein a hydrogen collection ratio defined by the following equation (1) is in a range of 20 to 99.9 vol %:
[hydrogen collection ratio]=100×{[permeation-side hydrogen flow rate]/([non-permeation-side hydrogen flow rate]+[permeation-side hydrogen flow rate])} . . . (1), in which the permeation-side hydrogen flow rate is a flow rate (m³/hr) of hydrogen that has permeated the selectively permeable membrane, and the non-permeation-side hydrogen flow rate is a flow rate (m³/hr) of hydrogen to be passed through the reactor and discharged from the reactor without permeating the selectively permeable membrane.
